(19) United States
(12) Patent Application Publication
(10) Pub. No.: US 2025/0108329 A1
(43) Pub. Date: Apr. 3, 2025

(54) N2O REMOVAL FROM A GASEOUS STREAM

(71) Applicant: UOP LLC, Des Plaines, IL (US)

(72) Inventors: Silpa S, Haryana (IN); Gautam Pandey, Harayana (IN); Jayant K. Gorawara, Buffalo Grove, IL (US); Arghya Maitra, Haryana (IN); Assaad Ghoussoub, Bracknell (GB); Stephen Caskey, Gurnee, IL (US)

(21) Appl. No.: 18/822,627

(22) Filed: Sep. 3, 2024

(30) Foreign Application Priority Data
Sep. 29, 2023 (IN) 202311065753

(51) Int. Cl. B01D 53/86

(52) U.S. Cl. CPC B01D 53/8628; B01D 2255/20761; B01D 2256/24

(57) ABSTRACT

Processes for selectively removing NOx from various gaseous streams are described. The gaseous streams, include, but are not limited to, hydrocarbon process streams, ammonia combustion gas streams, flue gas streams, cement kiln gas streams, and the like. The processes involve contacting the gaseous stream containing NOx with a catalyst in the presence of H₂. The NOx is converted to N₂ and H₂O. The purified gaseous stream has less NOx less than the level of NOx in the gaseous stream. The catalyst consists essentially of metallic copper on a support with optionally Cu₂O, CuO, ZrO₂, ZnO, TiO, CeO₂, NiO, or combinations thereof.

### CROSS-REFERENCES TO RELATED APPLICATIONS

This application claims the benefit of Indian Patent Applicant No. 202311065753 filed on Sep. 29, 2023, the entire disclosure of which is incorporated herein by way of reference.

### BACKGROUND

With the globally increasing polymer demand, polymer manufacturers are constantly seeking lower cost of production while maintaining high grade polymers. With the trend in decreasing fuel demand, most polymer manufacturer are working on integrated refinery-petrochemical plants to enable them to adjust with energy market dynamics. As a result, there are increasing threats from unconventional contaminants related to monomer purification. The presence of NOx has recently emerged as a serious problem for polymer catalysts. The source of the organic nitrogenous compounds in the refinery stream is the corrosion inhibitor, which slowly accumulates and generates NOx at the furnace outlet. NOx is detrimental to polymerization catalysts because it poisons Ziegler Natta or Metallocene catalysts irreversibly and reduces catalytic activity which slows down the polymerization reaction. Even a few ppm of N₂O results in reduced polymerization reaction rates and accounts for significant polymer yield loss, as well as production of lower grade polymers. Additionally NOx gums are known to deposit in the colder part of heat exchangers, cryogenic distillation units, and cold boxes. NOx gums are problematic due to plugging of piping. Furthermore, when re-heated, there could be chance of explosion.

NOx removal is important in other types of process as well, including various types of hydrocarbon process streams, ammonia combustion gas streams, flue gas streams, cement kiln gas streams, and the like.

Therefore, there is a need for improved processes for removing NOx from gaseous streams.

### DESCRIPTION OF THE INVENTION

In the present invention, NOx is selectively removed from various gaseous streams, including, but not limited to, hydrocarbon process streams, ammonia combustion gas streams, flue gas streams, cement kiln gas streams, and the like. NOx includes, but is not limited to, NO, N₂O, NO₂, N₂O₄, and the like. The processes involve contacting the gaseous stream containing NOx with a catalyst in the presence of H₂. The NOx is converted to N₂ and H₂O. The purified gaseous stream has less N₂O less than the level of N₂O in the gaseous stream. The catalyst consists essentially of metallic copper on a support. The current invention will also reduce the amount of NOx and improve process safety.

A gaseous stream containing N₂O and hydrogen are passed over a copper-based adsorbent at moderate temperature. Prior to beginning the process, copper oxide is reduced to the copper zero state by reduction, typically using hydrogen. In this reaction, metallic copper acts as a catalyst and does not change its oxidation state. The reaction continues for several hours without deactivation of the catalyst bed.

Cu N₂O+H₂→H₂O+N₂

The reaction temperature is typically in the range of 20° C. to 150° C., or 20° C. to 140° C., or 20° C. to 130° C., or 20° C. to 120° C., or 20° C. to 110° C., or 20° C. to 100° C., or 20° C. to 90° C., or 30° C. to 150° C., or 30° C. to 140° C., or 30° C. to 130° C., or 30° C. to 120° C., or 30° C. to 110° C., or 30° C. to 100° C., or 30° C. to 90° C., or 40° C. to 150° C., or 40° C. to 140° C., or 40° C. to 130° C., or 40° C. to 120° C., or 40° C. to 110° C., or 40° C. to 100° C., or 40° C. to 90° C., or 50° C. to 150° C., or 50° C. to 140° C., or 50° C. to 130° C., or 50° C. to 120° C., or 50° C. to 110° C., or 50° C. to 100° C., or 50° C. to 90° C., or 60° C. to 150° C., or 60° C. to 140° C., or 60° C. to 130° C., or 60° C. to 120° C., or 60° C. to 110° C., or 60° C. to 100° C., or 60° C. to 90° C. At temperatures below 60° C., the reaction has limited capacity, requiring more frequent catalyst regeneration. At temperatures above 110° C., more side reactions may occur depending on the feed being treated.

The ratio of N₂O:H₂ is typically in the range of 1:1 to 1:10, or 1:4 to 1:10, or combinations thereof. Below a ratio of 1:4, there may be incomplete NOx conversion. Operating above a ratio of 1:10 risks loss of ethylene or higher hydrogen slippage to the downstream process.

The catalyst consists essentially of metallic copper (Cu⁰) on a support. There can optionally be less than 15wt % of Cu₂O, and/or CuO (which would be less than 50wt % of the total copper content) (from incomplete reduction or subsequent oxidation), and less than 25% of ZrO₂, ZnO, TiO, CeO₂, NiO, or combinations thereof (which could replace part of the metal oxide support) (to modify the copper dispersion). The catalyst can comprise 5 to 90 wt % metallic copper, or 5 to 85 wt %, or 5 to 80 wt %, or 5 to 75 wt %, or 5 to 70 wt %, or 5 to 65 wt %, or 5 to 60 wt %, or 5 to 55 wt %, or 5 to 50 wt %, or 5 to 45 wt %, or 10 to 90 wt %, or 10 to 85 wt %, or 10 to 80 wt %, or 10 to 75 wt %, or 10 to 70 wt %, or 10 to 65 wt %, or 10 to 60 wt %, or 10 to 55 wt %, or 10 to 50 wt %, or 10 to 45 wt %, or 15 to 90 wt %, or 15 to 85 wt %, or 15 to 80 wt %, or 15 to 75 wt %, or 15 to 70 wt %, or 15 to 65 wt %, or 15 to 60 wt %, or 15 to 55 wt %, or 15 to 50 wt %, or 15 to 45 wt %.

The support may comprise a metal oxide support, a clay support, or combinations thereof.

The catalyst may be produced by providing copper oxide on the support and reducing the copper oxide to metallic copper. Any suitable reducing agent may be used to produce the catalyst. Suitable reducing agents include, but are not limited to, H₂.

The catalyst may be regenerated by contacting the catalyst with a reducing agent to maintain the metallic copper in a reduced stated during use. Any suitable reducing agent may be used to regenerate the catalyst. Suitable reducing agents include, but are not limited to, H₂. The H₂ may be present in a hydrogen stream comprising 1 to 100% H₂, or 50 to 100%, or 60 to 100%, or 70 to 100%, or 80 to 100%, or 90 to 100%, or 95 to 100%, or 97 to 100%, or 98 to 100%, or 99 to 100%. The catalyst may be contacted with the reducing agent at a temperature in a range of 150° C. to 300° C. to regenerate the catalyst.

The source of the gaseous feed stream will typically determine the level of NOx present in the feed stream. NOx may be inherent in the feed stream in some locations such as natural gas, it could be derived from nitrogen-based inhibitors present in the hydrocarbon feed, it could be derived by the hig temperature oxidation of ammonia or N₂ in flue gas stream, or it could be derived from recycle stream.

For hydrocarbon streams, the level of NOx in the purified gaseous stream is generally less than 2 ppmv, or less than 1.5 ppmv, or less than 1 ppmv, or less than 0.9 ppmv, or less than 0.8 ppmv, or less than 0.7 ppmv, or less than 0.6 ppmv, or less than 0.5 ppmv, or less than 0.4 ppmv, or less than 0.3 ppmv, or less than 0.2 ppmv.

In some embodiments, the process involves purifying a hydrocarbon stream. In some embodiments, the gaseous stream may comprise alkanes having 2 to 4 carbon atoms.

In some embodiments, the gaseous stream may comprise alkenes having 2 to 4 carbon atoms. Alkene (such as ethylene and propylene, for example) hydrogenation is not prominent in this process under typical reaction conditions.

In some embodiments, the gaseous stream may comprise comprises dienes and acetylenes having 2 to 4 carbon atoms. In some embodiments, the purified gaseous stream has a level of acetylene less than a level of acetylene in the gaseous stream. In some embodiments, the dienes and acetylenes in the purified gaseous stream are polymerized.

Thus, the same adsorbent bed can be designed for removal of both NOx and acetylene. The mechanism of contaminant removal is similar for both.

Another aspect of the invention is a process for removing NOx from a hydrocarbon stream. In one embodiment, the process comprises: contacting the hydrocarbon stream with a catalyst a temperature in a range of 60° C. to 90° C. in the presence of H₂ to convert the NOx to N₂ and H₂O and produce a purified hydrocarbon stream having 1 ppmv or less of NOx, the catalyst consisting essentially of metallic copper on a support, the hydrocarbon stream comprising NOx, and wherein a ratio of NOx:H₂ in a range of 1:4 to 1:10, and regenerating the catalyst by contacting the metallic copper with a H₂ at a temperature in a range of 150° C. to 300° C. wherein the H₂ is present in a hydrogen stream comprising 50 to 100% H₂.

The support may comprise a metal oxide support, a clay support, or combinations thereof, and wherein an amount of metallic copper in the catalyst is in a range of 5 to 90 wt %.

The hydrocarbon stream may comprise alkanes having 2 to 4 carbon atoms, or alkenes having 2 to 4 carbon atoms, or combinations thereof.

The catalyst may be produced by providing copper oxide on the support and reducing the copper oxide to metallic copper.

### EXAMPLES

### Example 1: N₂O Removal Without Hydrogen

NOx removal was tested in a flowthrough setup. A 30% CuO/alumina based adsorbent was pre-activated in 5% H₂ in balance N₂ at 200° C. for 6 hours. The adsorbent was cooled to the desired reaction temperature, i.e., 40, 90, 150, 250, or 300° C. An N₂O spiked N₂ gas sample was passed through the adsorbent at a space velocity of about 4300 GHSV and 40° C. (or other temperature). The breakthrough of N₂O was monitored by measurement of the outlet concentration of N₂O with an online infrared spectrometer until saturation. After saturation, optional, the activation and N₂O breakthrough steps were repeated to evaluate the cyclic performance of the adsorbent. The saturation capacity was calculated based on comparison of the inlet and outlet concentration of N₂O. Results are shown in Table 1.

TABLE 1

| Experimental | | Saturation |
|---|---|---|
| Temperature | Cycle | Capacity wt % |
| 40° C. | 1 | 0.40 |
| | 2 | 0.38 |
| | 3 | 0.38 |
| | 4 | 0.39 |
| 90° C. | 1 | 0.36 |
| | 2 | 0.35 |
| 150° C. | 1 | 0.4 |
| 250° C. | 1 | 16.2 |
| 300° C. | 1 | 17 |

### Example 2: N₂O Conversion with Hydrogen—Temperature Effect

NOx conversion was tested in a flowthrough setup. A 30% CuO/alumina based catalyst was pre-activated in 5% H₂ in balance N₂ at 200° C. for 6 hours. The catalyst was then cooled to the desired reaction temperature of 40, 70, 80, or 90° C. A 200 ppm N₂O spiked N₂ gas sample was mixed with hydrogen at a concentration equivalent to 10 times the N₂O on a molar basis. This mixed gas stream was passed through the catalyst at a space velocity of about 4300 GHSV and the reaction temperatures noted above. The conversion of N₂O was assessed by measurement of the outlet concentration of N₂O with an online infrared spectrometer. Results are shown in Table 2.

TABLE 2

| | Total Test | Breakthrough | N₂O |
|---|---|---|---|
| Temperature | Time | Observed | Conversion |
| ° C. | (hrs) | (Yes/No) | % |
| 40 | 1.5 | YES | 10 |
| 70 | 24 | No | 100 |
| 80 | 15 | No | 100 |
| 90 | 160 | No | 100 |

### Example 3: N₂O Conversion with Hydrogen—H₂ Concentration Effect

NOx conversion was tested in a flowthrough setup. A 30% CuO/alumina based catalyst was pre-activated in 5% H₂ in balance N₂ at 200° C. for 6 hours. The catalyst was then cooled to the desired reaction temperature of 90° C. Then a 200, 500 or 650 ppm N₂O spiked N₂ gas sample was mixed with hydrogen at a concentration equivalent to 2, 3, 4, 5, or 10 times the N₂O on a molar basis. This mixed gas stream was passed through the catalyst at a space velocity of about 4300 GHSV and 90° C. The conversion of N₂O was assessed by measurement of the outlet concentration of N₂O with an online infrared spectrometer. Results are shown in Table 3.

TABLE 3

| N₂O | H₂ | Total Test | Breakthrough | N₂O |
|---|---|---|---|---|
| Conc. | Conc. | Time | Observed (YES/ | Conversion |
| ppm | ppm | (hrs) | NO) | % |
| 200 | 2000 | 160 | No | 100 |
| 500 | 5000 | 15 | No | 100 |
| 500 | 2000 | 24 | No | 100 |
| 500 | 1500 | 1.5 | Yes | >95 |
| 650 | 1950 | 25 | Yes | 92.3 |

### Example 4: N₂O Conversion with Hydrogen and Ethylene

NOx conversion was tested in a flowthrough setup. A 30% CuO/alumina based catalyst was pre-activated in 5% H₂ in balance N₂ at 200° C. for 6 hours. The catalyst was then cooled to the desired reaction temperature of 90° C. Then a 50 or 200 ppm N₂O spiked N₂ gas sample was mixed with hydrogen and ethylene to produce a gas blend. This gas blend stream was passed through the catalyst at a space velocity of ˜4300 GHSV and 90° C. The conversion of N₂O was assessed by measurement of the 10 outlet concentration of N₂O with an online infrared spectrometer until saturation. Results are shown in Table 4.

TABLE 4

| | | | Total Test | N2O |
|---|---|---|---|---|
| N₂O | H₂ | | Time | Conversion |
| (ppm) | (ppm) | Stream | (hrs) | % |
| 200 | 2000 | Ethylene:N₂ | 72 | 100 |
| | | 50:50 | | |
| 50 | 500 | Ethylene:N₂ | 48 | 100 |
| | | 50:50 | | |

### SPECIFIC EMBODIMENTS

While the following is described in conjunction with specific embodiments, it will be understood that this description is intended to illustrate and not limit the scope of the preceding description and the appended claims.

A first embodiment of the invention is a process for removing NOx from a gaseous stream comprising contacting the gaseous stream with a catalyst in the presence of H₂ under catalytic reaction conditions to convert the NOx to N₂ and H₂O and produce a purified gaseous stream having a level of NOx less than a level of NOx in the gaseous stream, the catalyst consisting essentially of metallic copper on a support, the gaseous stream comprising NOx. An embodiment of the invention is one, any or all of prior embodiments in this paragraph up through the first embodiment in this paragraph wherein the reaction conditions comprise a temperature in a range of 20° C. to 150° C., or a ratio of NOx:H₂ in a range of 14 to 110, or combinations thereof. An embodiment of the invention is one, any or all of prior embodiments in this paragraph up through the first embodiment in this paragraph wherein an amount of metallic copper in the catalyst is in a range of 5 to 90 wt %. An embodiment of the invention is one, any or all of prior embodiments in this paragraph up through the first embodiment in this paragraph wherein the support comprises a metal oxide support, a clay support, or combinations thereof. An embodiment of the invention is one, any or all of prior embodiments in this paragraph up through the first embodiment in this paragraph wherein the gaseous stream comprises a hydrocarbon stream, a stream comprising ammonia combustions gases, a flue gas stream, a stream comprising cement kiln gases, or combinations thereof. An embodiment of the invention is one, any or all of prior embodiments in this paragraph up through the first embodiment in this paragraph wherein the level of NOx in the purified gaseous stream is less than 1 ppmv. An embodiment of the invention is one, any or all of prior embodiments in this paragraph up through the first embodiment in this paragraph wherein the gaseous stream comprises a hydrocarbon stream. An embodiment of the invention is one, any or all of prior embodiments in this paragraph up through the first embodiment in this paragraph wherein the gaseous stream comprises hydrocarbon alkanes having 2 to 4 carbon atoms. An embodiment of the invention is one, any or all of prior embodiments in this paragraph up through the first embodiment in this paragraph wherein the gaseous stream comprises alkenes having 2 to 4 carbon atoms. An embodiment of the invention is one, any or all of prior embodiments in this paragraph up through the first embodiment in this paragraph wherein the gaseous stream comprises dienes and acetylenes having 2 to 4 carbon atoms. An embodiment of the invention is one, any or all of prior embodiments in this paragraph up through the first embodiment in this paragraph wherein the purified gaseous stream has a level of acetylene less than a level of acetylene in the gaseous stream. An embodiment of the invention is one, any or all of prior embodiments in this paragraph up through the first embodiment in this paragraph further comprising polymerizing the dienes and acetylenes in the purified gaseous stream. An embodiment of the invention is one, any or all of prior embodiments in this paragraph up through the first embodiment in this paragraph wherein the catalyst is produced by providing copper oxide on the support and reducing the copper oxide to metallic copper. An embodiment of the invention is one, any or all of prior embodiments in this paragraph up through the first embodiment in this paragraph further comprising regenerating the catalyst by contacting the catalyst with a reducing agent to maintain the metallic copper in a reduced stated during use. An embodiment of the invention is one, any or all of prior embodiments in this paragraph up through the first embodiment in this paragraph wherein the reducing agent comprises H₂, and wherein the H₂ is present in a hydrogen stream comprising 1 to 100% H₂. An embodiment of the invention is one, any or all of prior embodiments in this paragraph up through the first embodiment in this paragraph wherein the catalyst is contacted with the reducing agent at a temperature in a range of 150° C. to 300° C.

A second embodiment of the invention is a process for removing NOx from a hydrocarbon stream comprising contacting the hydrocarbon stream with a catalyst a temperature in a range of 70° C. to 90° C. in the presence of H₂ to convert the N₂O to N₂ and H₂O and produce a purified hydrocarbon stream having 1 ppmv or less of NOx, the catalyst consisting essentially of metallic copper on a support, the hydrocarbon stream comprising NOx, and wherein a ratio of NOx:H₂ in a range of 110, and regenerating the catalyst by contacting the metallic copper with a H₂ at a temperature in a range of 150° C. to 300° C. wherein the H₂ is present in a hydrogen stream comprising 50 to 100% H₂. An embodiment of the invention is one, any or all of prior embodiments in this paragraph up through the second embodiment in this paragraph wherein the support comprises a metal oxide support, a clay support, or combinations thereof, and wherein an amount of metallic copper in the catalyst is in a range of 5 to 90 wt %. An embodiment of the invention is one, any or all of prior embodiments in this paragraph up through the second embodiment in this paragraph wherein the hydrocarbon stream comprises alkanes having 2 to 4 carbon atoms, or alkenes having 2 to 4 carbon atoms, or combinations thereof. An embodiment of the invention is one, any or all of prior embodiments in this paragraph up through the second embodiment in this paragraph wherein the catalyst is produced by providing copper oxide on the support and reducing the copper oxide to metallic copper.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for removing NOx from a gaseous stream comprising:
contacting the gaseous stream with a catalyst in the presence of H₂ under catalytic reaction conditions to convert the NOx to N₂ and H₂O and produce a purified gaseous stream having a level of NOx less than a level of NOx in the gaseous stream, the catalyst consisting essentially of metallic copper on a support, the gaseous stream comprising NOx.

2. The process of claim 1 wherein the reaction conditions comprise: a temperature in a range of 20° C. to 150° C., or a ratio of NOx:H₂ in a range of 1:4 to 1:10, or combinations thereof.

3. The process of claim 1 wherein an amount of metallic copper in the catalyst is in a range of 5 to 90 wt %.

4. The process of claim 1 wherein the support comprises a metal oxide support, a clay support, or combinations thereof.

5. The process of claim 1 wherein the gaseous stream comprises a hydrocarbon stream, a stream comprising ammonia combustions gases, a flue gas stream, a stream comprising cement kiln gases, or combinations thereof.

6. The process of claim 1 wherein the level of NOx in the purified gaseous stream is less than 1 ppmv.

7. The process of claim 1 wherein the gaseous stream comprises a hydrocarbon stream.

8. The process of claim 1 wherein the gaseous stream comprises hydrocarbon alkanes having 2 to 4 carbon atoms.

9. The process of claim 1 wherein the gaseous stream comprises alkenes having 2 to 4 carbon atoms.

10. The process of claim 1 wherein the gaseous stream comprises dienes and acetylenes having 2 to 4 carbon atoms.

11. The process of claim 10 wherein the purified gaseous stream has a level of acetylene less than a level of acetylene in the gaseous stream.

12. The process of claim 10 further comprising:
polymerizing the dienes and acetylenes in the purified gaseous stream.

13. The process of claim 1 wherein the catalyst is produced by providing copper oxide on the support and reducing the copper oxide to metallic copper.

14. The process of claim 1 further comprising:
regenerating the catalyst by contacting the catalyst with a reducing agent to maintain the metallic copper in a reduced stated during use.

15. The process of claim 14 wherein the reducing agent comprises H₂, and wherein the H₂ is present in a hydrogen stream comprising 1 to 100% H₂.

16. The process of claim 14 wherein the catalyst is contacted with the reducing agent at a temperature in a range of 150° C. to 300° C.

17. A process for removing NOx from a hydrocarbon stream comprising:
contacting the hydrocarbon stream with a catalyst a temperature in a range of 70° C. to 90° C. in the presence of H₂ to convert the N₂O to N₂ and H₂O and produce a purified hydrocarbon stream having 1 ppmv or less of NOx, the catalyst consisting essentially of metallic copper on a support, the hydrocarbon stream comprising NOx, and wherein a ratio of NOx:H₂ in a range of 1:10, and
regenerating the catalyst by contacting the metallic copper with a H₂ at a temperature in a range of 150° C. to 300° C. wherein the H₂ is present in a hydrogen stream comprising 50 to 100% H₂.

18. The process of claim 17 wherein the support comprises a metal oxide support, a clay support, or combinations thereof, and wherein an amount of metallic copper in the catalyst is in a range of 5 to 90 wt %.

19. The process of claim 17 wherein the hydrocarbon stream comprises alkanes having 2 to 4 carbon atoms, or alkenes having 2 to 4 carbon atoms, or combinations thereof.

20. The process of claim 17 wherein the catalyst is produced by providing copper oxide on the support and reducing the copper oxide to metallic copper.
